(19) United States
(12) Patent Application Publication
(10) Pub. No.: US 2026/0249728 A1
(43) Pub. Date: Aug. 27, 2026

(54) CHARGING DEVICE

(71) Applicant: DELTA ELECTRONICS, INC., Taoyuan City (TW)

(72) Inventor: Wei-Te HUANG, Taoyuan City (TW)

(21) Appl. No.: 19/263,462

(22) Filed: Jul. 8, 2025

(30) Foreign Application Priority Data
Feb. 26, 2025 (CN) 202510213994.3

(51) Int. Cl. B60L 53/62; B60L 53/16; B60L 53/30; B60L 53/66

(52) U.S. Cl. CPC B60L 53/62; B60L 53/16; B60L 53/305; B60L 53/66

(57) ABSTRACT

A charging device, comprising a connector, a controller and a control switch. The connector comprises a power terminal and a signal terminal. The controller is coupled to the power terminal and a power supply circuit, and is configured to control the a power supply switch in the power supply circuit to provide a supply power to the power terminal. The controller further comprises a detection terminal and a data terminal. The control switch is coupled between the controller and the connector. One terminal of the control switch is coupled to the signal terminal, and the other terminal of the control switch is selectively connected to the detection terminal or the data terminal.

### CROSS-REFERENCE TO RELATED APPLICATION

This application claims priority to China Application Serial Number 202510213994.3, filed Feb. 26, 2025, which is herein incorporated by reference in its entirety.

### BACKGROUND

### Technical Field

The present disclosure relates to charging technology, and more particularly to a charging device.

### Description of Related Art

Recently, with the improvement of environmental awareness, the development of electric vehicles has received more and more attention. In order to make electric vehicles more popular, “charging device” (e.g., charging stations) that provide charging services is crucial. Therefore, how to improve the convenience of charging devices and improve maintenance costs has become a major issue at present.

### SUMMARY

One aspect of the present disclosure is a charging device, comprising a connector, a controller and a control switch. The connector comprises a power terminal and a signal terminal. The controller is coupled to the power terminal and a power supply circuit, and is configured to control the a power supply switch in the power supply circuit to provide a supply power to the power terminal. The controller further comprises a detection terminal and a data terminal. The control switch is coupled between the controller and the connector. One terminal of the control switch is coupled to the signal terminal, and the other terminal of the control switch is selectively connected to the detection terminal or the data terminal.

Another aspect of the present disclosure is a charging device, comprising: a connector comprising a power terminal and a signal terminal; a controller coupled to the power terminal, and configured provide a supply power to the power terminal, wherein the controller further comprises a detection terminal and a data terminal; and a control switch coupled between the controller and the connector, wherein one terminal of the control switch is coupled to the signal terminal; wherein when an external connector is connected to the connector, the charging device is configured to detect a contact state between the external connector and the connector, or detect an external impedance value of the external connector, so as to selectively control the other terminal of the control switch to be selectively connected to the detection terminal or the data terminal.

It is to be understood that both the foregoing general description and the following detailed description are by examples, and are intended to provide further explanation of the disclosure as claimed.

### BRIEF DESCRIPTION OF THE DRAWINGS

The present disclosure can be more fully understood by reading the following detailed description of the embodiment, with reference made to the accompanying drawings as follows:

FIG. 1A is a schematic diagram of a charging device in some embodiments of the present disclosure.

FIG. 1B is a schematic diagram of a connector in some embodiments of the present disclosure.

FIG. 2 is a schematic diagram of a charging device in some embodiments of the present disclosure.

FIGS. 3A-3B are schematic diagrams of one application of the charging device in some embodiments of the present disclosure.

FIGS. 4A-4B are schematic diagrams of another application of the charging device in some embodiments of the present disclosure.

FIGS. 5A-5B are schematic diagrams of another application of the charging device in some embodiments of the present disclosure.

### DETAILED DESCRIPTION

For the embodiment below is described in detail with the accompanying drawings, embodiments are not provided to limit the scope of the present disclosure. Moreover, the operation of the described structure is not for limiting the order of implementation. Any device with equivalent functions that is produced from a structure formed by a recombination of elements is all covered by the scope of the present disclosure. Drawings are for the purpose of illustration only, and not plotted in accordance with the original size.

It will be understood that when an element is referred to as being “connected to” or “coupled to”, it can be directly connected or coupled to the other element or intervening elements may be present. In contrast, when an element to another element is referred to as being “directly connected” or “directly coupled,” there are no intervening elements present. As used herein, the term “and/or” includes associated listed items or any and all combinations of more.

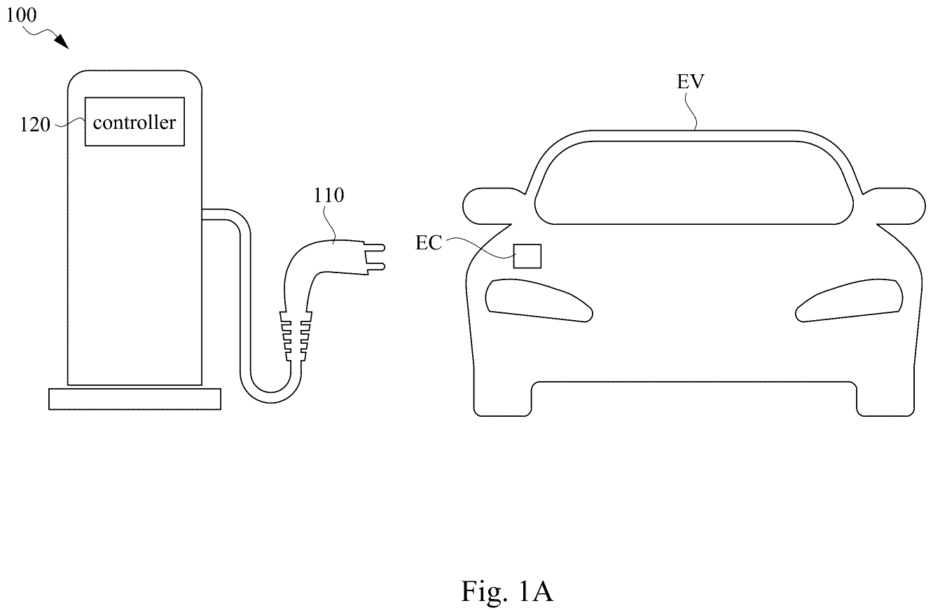

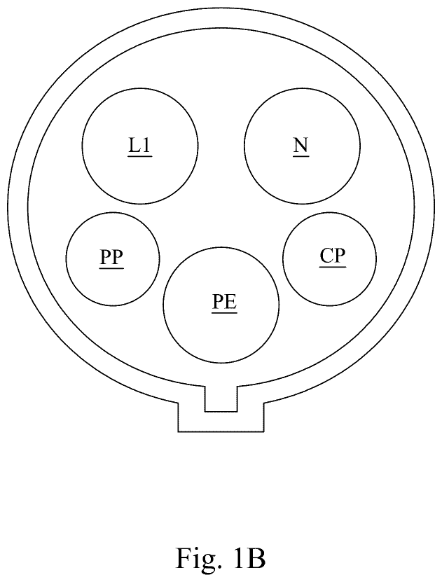

FIG. 1A is a schematic diagram of a charging device 100 in some embodiments of the present disclosure. The charging device 100 includes a connector 110 and a controller 120. In this embodiment, the charging device 100 is used as a part of a charging station (charging pile), and is configured to provide power to an electric vehicle EV. As shown in FIG. 1A, the connector 110 of the charging device 100 is configured to connect to a charging port EC of the electric vehicle EV, so as to use the power stored in the grid or the charging station to charge the electric vehicle EV.

The charging device 100 of the present disclosure is not limited to the charging station. In some embodiments, the charging device may be used as a charging connector (e.g., the charging port EC) of the electric vehicle EV, which is configured to connect to the charging plug/socket of the charging station to obtain power. In other words, the charging device of the present disclosure can be applied to either the “charging side” or the “power supply side”.

When transmitting power, the specifications of the charging side and the power supply side must be consistent. That is, the terminal configurations of the connectors must correspond to each other so that power can be transmitted correctly. To clearly illustrate the application of the present disclosure, the terminal configuration is first illustrated using FIG. 1B as an example.

FIG. 1B is a schematic diagram of the connector 110 in some embodiments of the present disclosure. According to different transmission contents, multiple terminals in the connector 110 can be divided into “power terminal” for transmitting power and “signal terminal” for transmitting data. In this embodiment, the connector 110 includes multiple power terminals L1, N (neutral line) and PE (ground line) for transmitting AC current, and includes multiple signal terminals PP and CP. Although the embodiment of FIG. 1B is an AC charging connector, the present disclosure is not limited thereto. In some other embodiments, as long as the connector includes the power terminal for transmitting power and the signal terminal for transmitting data, it can be applied as “connector” described in the subsequent embodiments (e.g., the DC charging connector, the three-phase AC charging connector).

Among the aforementioned multiple terminals, the signal terminal PP is configured to transmit control signals and communication signals between “the charging side” and “the power supply side”. For example, determining whether the connector is connected correctly, transmitting a specific voltage to indicate a specific charging mode, etc. The signal terminal CP is configured to transmit identification signals between “the charging side” and “the power supply side”, such as charging request signals, charging monitoring signals or charging abnormality signals, and transmit specific pulse width modulation signals to indicate the magnitude of the transmission current.

The terminal configuration shown in FIG. 1B is only one embodiment of the present disclosure, and the present disclosure is not limited thereto. In some other embodiments, the connector may have a different charging specification/interface and may have a different terminal configuration. In other words, the connector has at least one power terminal and at least one signal terminal, and the number and configuration of the terminals can be adjusted according to the actual application specifications.

Referring to FIG. 1A and FIG. 1B, the controller 120 determines the method of providing supply power by the charging device 100 (e.g., the power supply method) according to a control file (e.g., firmware, program, data, parameters), such as the current of the power supply, the duration of the power supply, and the identification codes of different types of devices. The control file will be checked or updated regularly or irregularly to ensure that the charging device 100 operates normally.

Taking the charging station as an example, the controller 120 is usually arranged inside the charging station. When updating the control file, the maintenance staff must remove the housing of the charging station to connect a computer to the controller 12, so as to detect or update the control file. However, this method is not only time-consuming, but also easily damages the waterproof structure of the housing. Therefore, the present disclosure has been improved to address this issue.

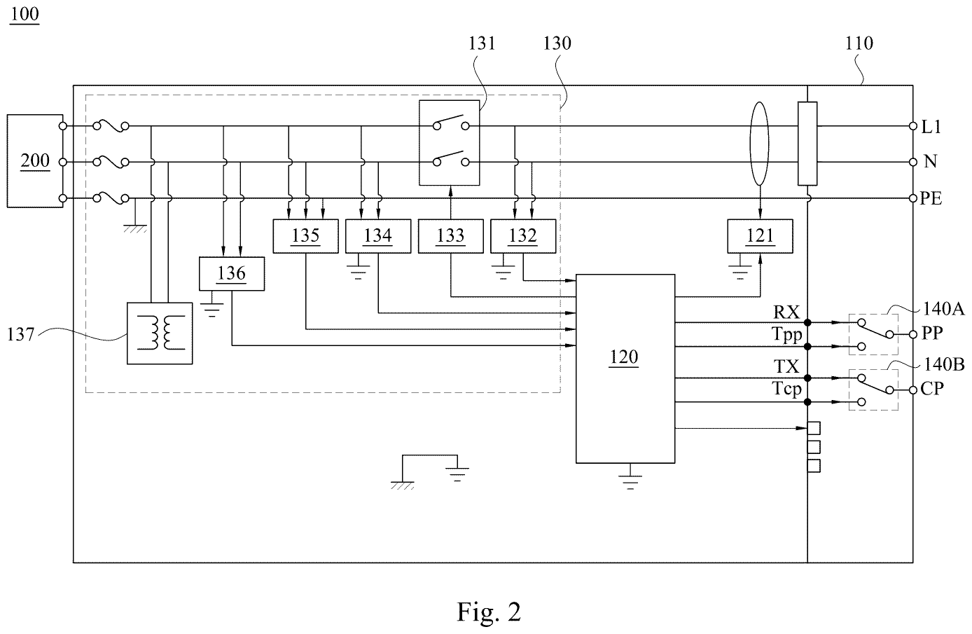

FIG. 2 is a schematic diagram of the charging device 100 in some embodiments of the present disclosure. The charging device 100 may correspond to the embodiments of FIG. 1A and FIG. 2. The charging device 100 includes a connector 110, a controller 120, a power supply circuit 130 and control switches 140A, 140B, and the connector 110 and the controller 120 can be connected via a transmission line (not shown in FIG. 2). As mentioned above, the connector 110 includes at least one power terminal and at least one signal terminal, such as the power terminals L1/N/PE and the signal terminals PP, CP shown in FIG. 2, but the number of terminals is not limited thereto.

The controller 120 is respectively coupled to the power terminals L1/N/PE and the power supply circuit 130. The power supply circuit 130 is respectively coupled to the power unit 200 (e.g., the power grid or the energy storage battery) and the controller 120, and includes a power supply switch 131. As shown in FIG. 2, the power supply switch 131 is coupled between the power terminals L1/N/PE and the power unit 200. The controller 120 can selectively provide the supply power to the power terminals or stop supplying power by controlling the on or off of the power supply switch 131.

The controller 120 further includes at least one detection terminal and at least one data terminal. The detection terminal is configured to receive a detection signal (e.g., charging request signal or load signal), so that the controller 120 can confirm that the current state is “charging state”, turn on the power supply switch 131, and make the charging device 100 output the supply power through the power supply switch 131 and the power terminals. The data terminal is configured to transmit the control file. As mentioned above, the number of the detection terminals and the data terminals can be adjusted according to actual specifications or requirements, and the present disclosure is not limited to the configuration shown in FIG. 2.

In this embodiment, the controller 120 further includes detection terminals Tpp, Tcp and data terminals RX, TX. The detection terminals Tpp, Tcp respectively correspond to the signal terminals PP, CP. In other words, the controller 120 receives the detection signal through the detection terminals Tpp, Tcp, and receives the updated control file through the data terminals RX, TX.

The control switch is coupled between the connector 110 and the controller 120, and the number of the control switch corresponds to the number of the signal terminals PP, CP. In this embodiment, the charging device 100 includes two control switches 140A, 140B. One terminal of the control switch 140A is coupled to the signal terminal PP, and the other terminal of the control switch 140A is controlled by the controller 120 to selectively conduct/connect to the detection terminal Tpp or the data terminal RX. From another perspective, the two selection terminals of the control switch 140A can be respectively coupled to the detection terminal Tpp or the data terminal RX, and the controller 120 is configured to control the conduction direction/target of the control switch 140A.

Similarly, one terminal of the control switch 140B is coupled to the signal terminal CP, and the other terminal of the control switch 140B is controlled by the controller 120 to selectively conduct/connect to the detection terminal Tcp or the data terminal TX. From another perspective, the two selection terminals of the control switch 140B can be respectively coupled to the detection terminal Tcp or the data terminal TX, and the controller 120 is configured to control the conduction direction/target of the control switch 140B.

When an external connector (e.g., the charging port EC shown in FIG. 1A) is connected to the connector 110, the charging device 100 can detect a contact state between the external connector and the connector 110, or detect an external impedance value of the external connector, so as to selectively control the other terminal of the control switches 140A/140B to be connected/conducted to the detection terminal (e.g., the detection terminal Tpp) or the data terminal (e.g., the data terminal RX). The specific determination method will be described in detail in the following paragraphs.

Accordingly, by selectively changing the connection/conduction target using the control switch 140A/140B, the charging device 100 can transmit power or receive data in response to different usage situations without changing the terminal configuration of the connector 110. In other words, the maintenance staff can use the connector 110 to update the control file without having to open the housing of the charging station, thereby effectively improving the convenience of use and maintenance cost of the charging device 100.

Specifically, when the external connector is connected to the connector 110, and the other terminal of the control switch 140A/140B is connected to the data terminal RX/TX, the controller 120 will confirm that the current state is not in the “power supply state” but in the “maintenance state”. At this time, the controller 120 stops outputting the supply power and receives the update data through the data terminal RX/TX. The controller 120 updates or checks the control file according to update data.

As mentioned above, in some embodiments, the controller 120 stores a preset value (e.g., a specific impedance value) used for making a determination, and is configured to identify the computer or the fixture of the maintenance staff. When the external connector is connected to the connector 110, the controller 120 can actively detect the external impedance value of the external connector. If the external impedance value corresponds to the preset value, it means that the charging device 100 is connected to the computer or the fixture of the maintenance staff, and the controller 120 will receive the update data.

On the other hand, when the external connector is connected to the connector 110, and the other terminal of the control switch 140A/140B is connected to the detection terminal Tpp/Tcp, the controller 120 will confirm that the current state is in the “power supply state”. At this time, the controller 120 turns on the power supply switch 131 to output the supply power through the power terminals.

In some embodiments, the controller 120 further includes a protection circuit 121(e.g., residual current device module), the protection circuit 121 is coupled to (e.g., through contactless electromagnetic induction) the power terminal L1/N, and is configured to detect abnormal leakage current.

In some embodiments, the power supply circuit 130 includes a contact detection circuit 132, a driving circuit 133, a voltage detection circuit 134, a current detection circuit 135, a ground detection circuit 136 and an auxiliary power supply circuit 137. The above circuits 132-137 are coupled to the power terminal and the controller 120.

The contact detection circuit 132 is configured to detect whether the connection relationship of the power supply switch 131 is wrong. The driving circuit 133 is configured to transmit the control signal of the controller 120 to turn on or off the power supply switch 131. The voltage detection circuit 134 and the current detection circuit 135 respectively detect the voltage value and the current value in the power supply circuit 130 to determine whether the supply power meets the safety range.

The ground detection circuit 136 can use the GMI (Ground Monitor Interrupter) to detect the ground connection status of the power supply circuit 130. When detecting a problem, the ground detection circuit 136 cuts off the power supply, preventing potential electrical risks. The auxiliary power supply circuit 137 is configured to provide power to various circuits in the charging device 100 (e.g., to the controller 120) to ensure the normal operation of the charging device 100.

The following describes different ways in which the charging device 100 detects “the contact state between the external connector and the connector 110” or “the external impedance value of the external connector” in different embodiments of the present disclosure.

Referring to FIG. 2, in one embodiment, the charging device 100 performs the determination by “electrical detection”. That is, the controller 120 detects the external impedance value from the external connector (e.g., the charging port EC shown in FIG. 1A) as the detection signal to determine the device type corresponding to the external connector and control/determine whether the other terminal of the control switch should be connected/conducted to the detection terminal or the data terminal.

For example, the controller 120 stores multiple impedance parameters corresponding to different types of the electric vehicles or the fixtures of the maintenance staff (e.g., dedicated maintenance computers). When the external connector is connected to the connector 110, the controller 120 detects the external impedance value (e.g., the impedance value of a specific load resistor in the external connector) of the external connector through the signal terminals PP/CP. Then, the controller 120 may compare the external impedance value with the impedance parameter to determine whether the external connector belongs to the electric vehicle or the fixture of the maintenance staff. If the external connector belongs to the electric vehicle, the controller 120 controls the control switch 140A/140B to connect/conduct to the detection terminal Tpp/Tcp, and provides the supply power to the power terminals. If the external connector belongs to the fixture of the maintenance staff, the controller 120 controls the control switch 140A/140B to connect/conduct to the data terminal RX/TX. At this time, the controller 120 stops outputting the supply power and receives the update data through the data terminal RX/TX.

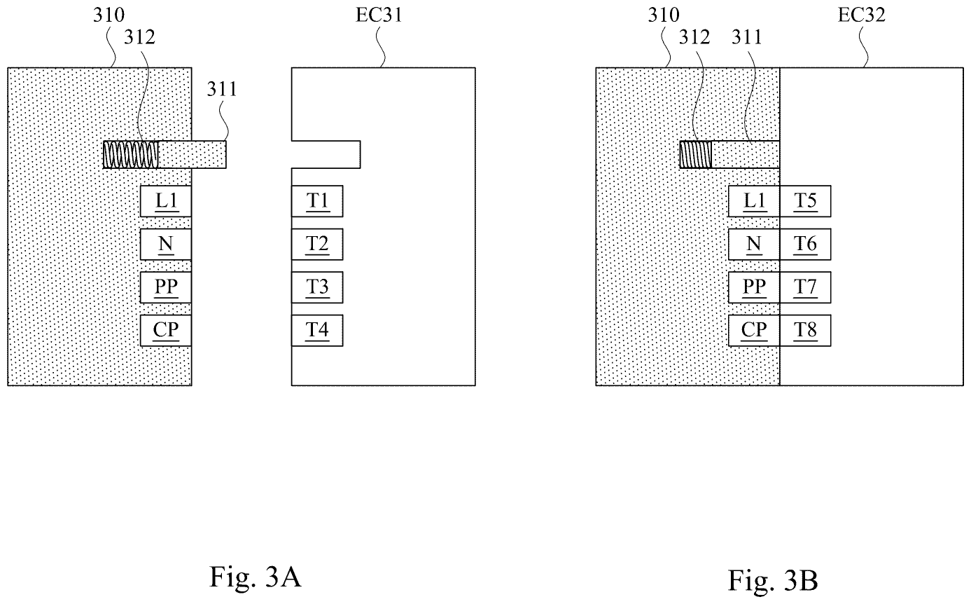

FIGS. 3A-3B are schematic diagrams of one application of the charging device in some embodiments of the present disclosure. In this embodiment, the charging device uses “physical method” to determine the contact state between the external connector and the connector. Referring to FIG. 2 and FIG. 3A, the connector 310 may be used to implement the connector 110 shown in FIG. 2.

The connector 310 includes a trigger element 311(e.g., push rod or button), the trigger element 311 is connected to the control switch (e.g., connected to the control switch 140A/140B in FIG. 2), and is configured to drives the other terminal of the control switch 140A/140B according to external force, so that the other terminal of the control switch 140A/140B selectively contacts the detection terminal Tpp/Tcp, or contacts the data terminal RX/TX.

In one embodiment, the connector 310 further includes a elastic element 312 (e.g., spring), the elastic element 312 is configured to make the trigger element 311 protrude from the surface of the connector 310 when not affected by external force.

As shown in FIG. 3A, the external connector EC31 is a connection plug for the fixture of the maintenance staff and has a groove. When the external connector EC31 is connected to the connector 310 (i.e., the terminals L1/N/PP/CP contact the terminals T1-T4), the trigger element 311 will not be pushed by the external force, so the other terminal of the control switch 140A/140B remains in contact with the data terminal RX/TX to transmit the update data.

On the other hand, as shown in FIG. 3B, the external connector EC32 is a charging port of the electric vehicle and has a flat contact surface. When the external connector EC32 is connected to the connector 310 (i.e., the terminals L1/N/PP/CP contact the terminals T5-T8), the trigger element 311 will be pushed by the external force, compressing the elastic element 312, and causing the other terminal of the control switch 140A/140B to contact the detection terminal Tpp/Tcp. At this time, the controller 120 can receive the detection signal (e.g., the external impedance value) through the detection terminal Tpp/Tcp to determine the type of the electric vehicle and exchange charging information. In one embodiment, when the control switch is connected to the detection terminal, the controller 120 can control/adjust the magnitude of the supply power (e.g., adjust the current value) according to the external impedance value.

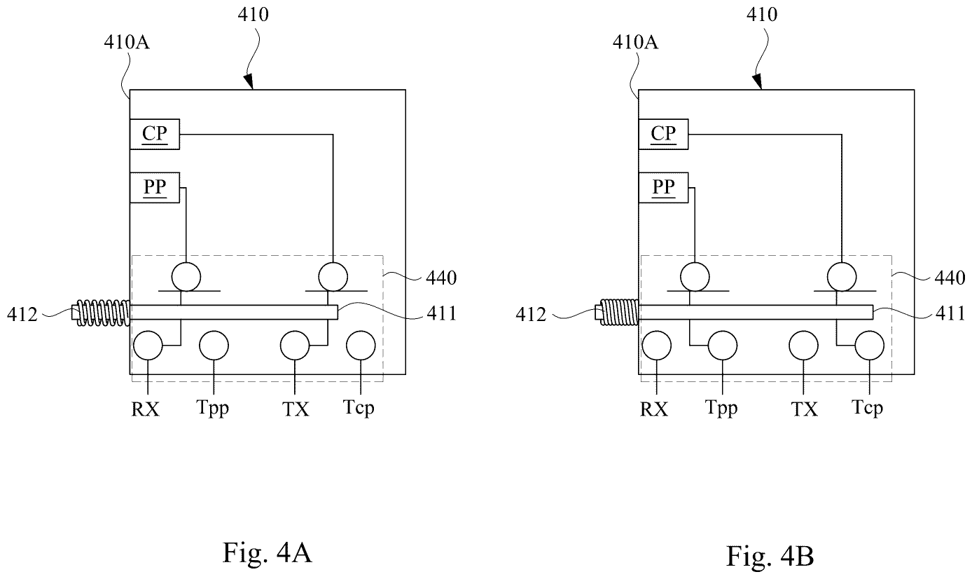

FIGS. 4A-4B are schematic diagrams of another application of the charging device in some other embodiments of the present disclosure. In this embodiment, the charging device uses “physical method” to determine the contact state between the external connector and the connector. The connector 410 may be used to implement the connector 110 shown in FIG. 2.

As shown in FIG. 4A, the trigger element 411 is connected to the control switch 440, and the elastic element 412 makes one terminal of the trigger element 411 protrude from the charging contact surface 410A of the connector 410 when not affected by external force. At this time, the control switch 440 respectively connects/conducts the signal terminal PP/CP to the data terminal RX/TX. When the trigger element 411 is pushed by an external force, as shown in FIG. 4B, the trigger element 411 will move and drive the control switch 440, so that the control switch 440 respectively connect/conduct the signal terminal PP/CP to the detection terminals Tpp/Tcp.

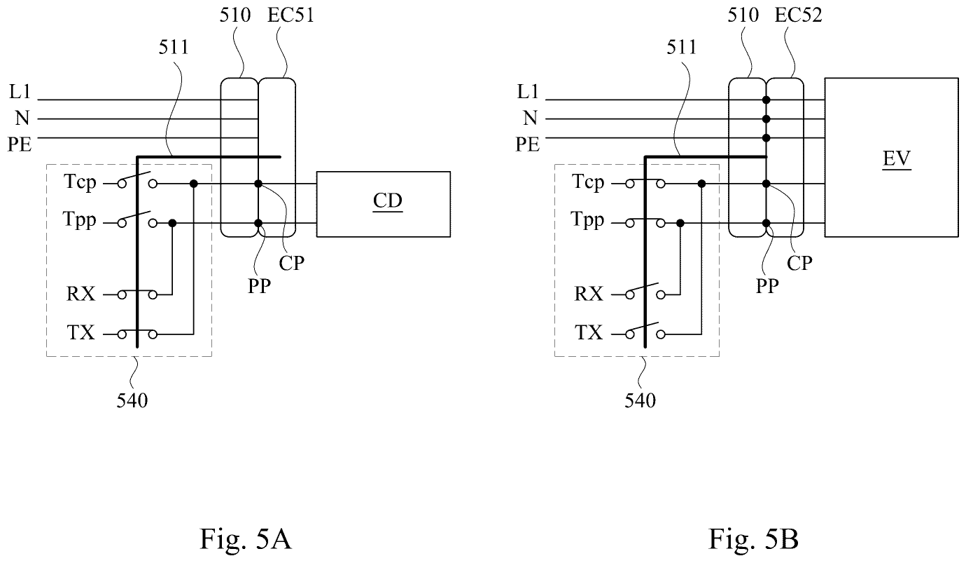

FIGS. 5A-5B are schematic diagrams of another application of the charging device in some other embodiments of the present disclosure. In this embodiment, the charging device uses “physical method” to determine the contact state between the external connector and the connector. The connector 510 may be used to implement the connector 110 shown in FIG. 2 or the connector 310 shown in FIG. 3A.

As shown in FIG. 5A, the external connector EC51 is a connecting plug of the fixture CD of the maintenance staff, and has a groove corresponding to the trigger element 511. Therefore, when the external connector EC51 is connected to the connector 510, the trigger element 511 will not be pushed by the external force. The other terminal of the control switch 540 will remain in contact with the data terminal RX/TX to transmit the update data.

On the other hand, as shown in FIG. 5B, the external connector EC52 is the charging port of the electric vehicle EV, and has a flat contact surface.

Therefore, when the external connector EC52 is connected to the connector 510, the trigger element 511 is pushed by the external force, so that the other terminal of the control switch 540 is disconnct from the data terminal RX/TX and contacts the detection terminal Tpp/Tcp instead.

At this time, the controller can receive the detection signal (e.g., the external impedance value) through the detection terminal Tpp/Tcp to determine the type of the electric vehicle, and then output the supply power through the power terminal L1/N/PE.

The elements, method steps, or technical features in the foregoing embodiments may be combined with each other, and are not limited to the order of the specification description or the order of the drawings in the present disclosure.

It will be apparent to those skilled in the art that various modifications and variations can be made to the structure of the present disclosure without departing from the scope or spirit of the present disclosure. In view of the foregoing, it is intended that the present disclosure cover modifications and variations of this present disclosure provided they fall within the scope of the following claims.

What is claimed is:

1. A charging device, comprising:
a connector comprising a power terminal and a signal terminal;
a controller coupled to the power terminal and a power supply circuit, and configured to control a power supply switch in the power supply circuit to provide a supply power to the power terminal, wherein the controller further comprises a detection terminal and a data terminal; and
a control switch coupled between the controller and the connector, wherein one terminal of the control switch is coupled to the signal terminal, and the other terminal of the control switch is selectively connected to the detection terminal or the data terminal.

2. The charging device of claim 1, wherein when the other terminal of the control switch is connected to the data terminal, the connector is configured to stop outputting the supply power, and the controller is configured to receive a update data through the data terminal.

3. The charging device of claim 2, wherein when an external connector is connected to the connector, the controller is configured to detect an external impedance value of the external connector, and when the controller determines that the external impedance value corresponds to a preset value, the controller receives the update data through the data terminal.

4. The charging device of claim 2, wherein the controller is configured to update a control file in the controller according to the update data, and the control file is configured to determine a power supply method for the charging device to output the supply power.

5. The charging device of claim 1, wherein when the other terminal of the control switch is connected to the detection terminal, the connector is configured to output the supply power through the power terminal.

6. The charging device of claim 5, wherein when the controller receive a detection signal through the detection terminal, the controller is configured to turn on the power supply switch to provide the supply power to the power terminal through the power supply switch.

7. The charging device of claim 1, wherein the connector comprises a trigger element, the trigger element is coupled to the control switch, and is configured to drive the other terminal of the control switch according to an external force, so that the other terminal of the control switch is selectively connected to the detection terminal or the data terminal.

8. The charging device of claim 7, wherein when the trigger element is not affected by the external force, the other terminal of the control switch is connected to the data terminal; when the trigger element is affected by the external force, the other terminal of the control switch is connected to the detection terminal.

9. The charging device of claim 8, wherein the connector further comprises an elastic element, the elastic element is configured to make the trigger element protrude from a charging contact surface of the connector when the trigger element is not affected by the external force.

10. The charging device of claim 1, wherein when an external connector is connected to the connector, the controller is configured to detect an external impedance value of the external connector, and control the other terminal of the control switch to be connected to the detection terminal or the data terminal according to the external impedance value.

11. A charging device, comprising:
a connector comprising a power terminal and a signal terminal;
a controller coupled to the power terminal, and configured provide a supply power to the power terminal, wherein the controller further comprises a detection terminal and a data terminal; and
a control switch coupled between the controller and the connector, wherein one terminal of the control switch is coupled to the signal terminal;
wherein when an external connector is connected to the connector, the charging device is configured to detect a contact state between the external connector and the connector, or detect an external impedance value of the external connector, so as to selectively control the other terminal of the control switch to be selectively connected to the detection terminal or the data terminal.

12. The charging device of claim 11, wherein when the other terminal of the control switch is connected to the data terminal, the connector is configured to stop outputting the supply power, and the controller is configured to receive a update data through the data terminal.

13. The charging device of claim 12, wherein when the controller determines that the external impedance value corresponds to a preset value, the controller receives the update data through the data terminal.

14. The charging device of claim 12, wherein the controller is configured to update a control file in the controller according to the update data, and the control file is configured to determine a power supply method for the charging device to output the supply power.

15. The charging device of claim 11, wherein when the other terminal of the control switch is connected to the detection terminal, the connector is configured to output the supply power through the power terminal.

16. The charging device of claim 15, further comprising:
a power supply circuit coupled to the controller, and comprising a power supply switch, wherein when the controller receive a detection signal through the detection terminal, the controller is configured to turn on the power supply switch to provide the supply power to the power terminal through the power supply switch.

17. The charging device of claim 11, wherein the connector comprises a trigger element, the trigger element is coupled to the control switch, and is configured to drive the other terminal of the control switch according to an external force, so that the other terminal of the control switch is selectively connected to the detection terminal or the data terminal.

18. The charging device of claim 17, wherein when the trigger element is not affected by the external force, the other terminal of the control switch is connected to the data terminal; when the trigger element is affected by the external force, the other terminal of the control switch is connected to the detection terminal.

19. The charging device of claim 18, wherein the connector further comprises an elastic element, the elastic element is configured to make the trigger element protrude from a charging contact surface of the connector when the trigger element is not affected by the external force.

20. The charging device of claim 11, wherein when the other terminal of the control switch is connected to the detection terminal, the controller controls a magnitude of the supply power according to the external impedance value.
